(19) United States
(12) Patent Application Publication
(10) Pub. No.: US 2009/0055158 A1
(43) Pub. Date: Feb. 26, 2009

(54) Speech translation apparatus and method

(75) Inventors: Dawei Xu, Fuchu-shi (JP); Takehiko Kagoshima, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/230,036

(22) Filed: Aug. 21, 2008

(30) Foreign Application Priority Data
Aug. 21, 2007 (JP) 2007-214956

(51) Int. Cl. G06F 17/28; G10L 11/00

(52) U.S. Cl. 704/2; 704/277; 704/E13.011

(57) ABSTRACT

A speech translation apparatus includes a speech recognition unit configured to recognize input speech of a first language to generate a first text of the first language, an extraction unit configured to compare original prosody information of the input speech with first synthesized prosody information based on the first text to extract paralinguistic information about each of first words of the first text, a machine translation unit configured to translate the first text to a second text of a second language, a mapping unit configured to allocate the paralinguistic information about each of the first words to each of second words of the second text in accordance with synonymity, a generating unit configured to generate second synthesized prosody information based on the paralinguistic information allocated to each of the second words, and a speech synthesis unit configured to synthesize output speech based on the second synthesized prosody information.

### CROSS-REFERENCE TO RELATED APPLICATIONS

This application is based upon and claims the benefit of priority from prior Japanese Patent Application No. 2007-214956, filed Aug. 21, 2007, the entire contents of which are incorporated herein by reference.

### BACKGROUND OF THE INVENTION

1. Field of the Invention

The present invention relates to a speech translation apparatus and method, which perform speech recognition, machine translation and speech synthesis, thereby translating input speech of a first language into output speech of a second language.

2. Description of the Related Art

Any speech translation apparatus hitherto developed performs three steps, i.e., speech recognition, machine translation, and speech synthesis, thereby translating input speech in a first language into output speech in a second language. That is, it performs step (a) of recognizing input speech of the first language, generating a text of the first language, step (b) of performing machine translation on the text of the first language, generating a text of the second language, and step (c) of performing speech synthesis on the text of the second language, generating output speech of the second language.

The input speech contains not only linguistic information that can be represented by texts, but also so-called paralinguistic information. The paralinguistic information is prosody information that shows the speaker's emphasis, intension and attitude. The paralinguistic information cannot be represented by texts, and will be lost in the process of recognizing the input speech. Inevitably, it is difficult for the conventional speech translation apparatus to generate output speech that reflects the paralinguistic information.

JP-A H6-332494 (KOKAI) descloses a speech translation apparatus that analyzes input speech, extracts words with an accent from the input speech, and adds accents to those words of the output speech, which are equivalent to the words extracted from the input speech. JP-A 2001-117922 (KOKAI) discloses a speech translation apparatus that generates a translated speech in which the word order are changed and appropriate case particles are used, thus reflecting the prosody information.

The speech translation apparatus disclosed in JP-A H6-332494 (KOKAI) merely analyzing the words with accents, based on the linguistic information contained in the input speech, and then adding accents to the equivalent words included in the translated speech. It does not reflect the paralinguistic information in the output speech.

The speech translation apparatus disclosed in JP-A 2001-117922 (KOKAI) is disadvantageous in that the input speech is limited to such a language in which prosody information can be represented by changing the word order and using appropriate case particles. Hence, this speech translation apparatus cannot generate a translated speech sufficiently reflecting the prosody information if the input speech is in, for example, a Western language in which the word order changes but a little or in Chinese which has no case particles.

### BRIEF SUMMARY OF THE INVENTION

According to an aspect of the invention, there is provided a speech translation apparatus that comprises a speech recognition unit configured to recognize input speech of a first language to generate a first text of the first language, a prosody analysis unit configured to analyze a prosody of the input speech to obtain original prosody information, a first language-analysis unit configured to split the first text into first words to obtain first linguistic information, a first generating unit configured to generate first synthesized prosody information based on the first linguistic information, an extraction unit configured to compare the original prosody information with the first synthesized prosody information to extract paralinguistic information about each of the first words, a machine translation unit configured to translate the first text to a second text of a second language, a second language-analysis unit configured to split the second text into second words to obtain second linguistic information, a mapping unit configured to allocate the paralinguistic information about each of the first words to each of the second words in accordance with synonymity, and a second generating unit configured to generate second synthesized prosody information based on the second linguistic information and the paralinguistic information allocated to each of the second words; and a speech synthesis unit configured to synthesize output speech based on the second linguistic information and the second synthesized prosody information.

### BRIEF DESCRIPTION OF THE SEVERAL VIEWS OF THE DRAWING

FIG. 1 is a block diagram showing a speech translation apparatus according to an embodiment;

FIG. 2 is a flowchart explaining how the speech translation apparatus of FIG. 1 operates;

FIG. 3 is a graph representing an exemplary logarithmic basic-frequency locus acquired by analyzing the original prosody information by means of the prosody analysis unit shown in FIG. 1;

FIG. 4 is a graph representing an exemplary logarithmic basic-frequency locus of the first synthesized prosody information generated by the first generating unit shown in FIG. 1;

FIG. 5 is a graph representing an exemplary logarithmic basic-frequency locus of the synthesized prosody information generated from only the second linguistic information by the second generating unit shown in FIG. 1; and

FIG. 6 is a graph representing an exemplary logarithmic basic-frequency locus of the synthesized prosody information acquired by correcting the logarithmic basic-frequency locus of FIG. 5 by using paralinguistic information.

### DETAILED DESCRIPTION OF THE INVENTION

Embodiments of the present invention will be described with reference to the accompanying drawings.

### First Embodiment

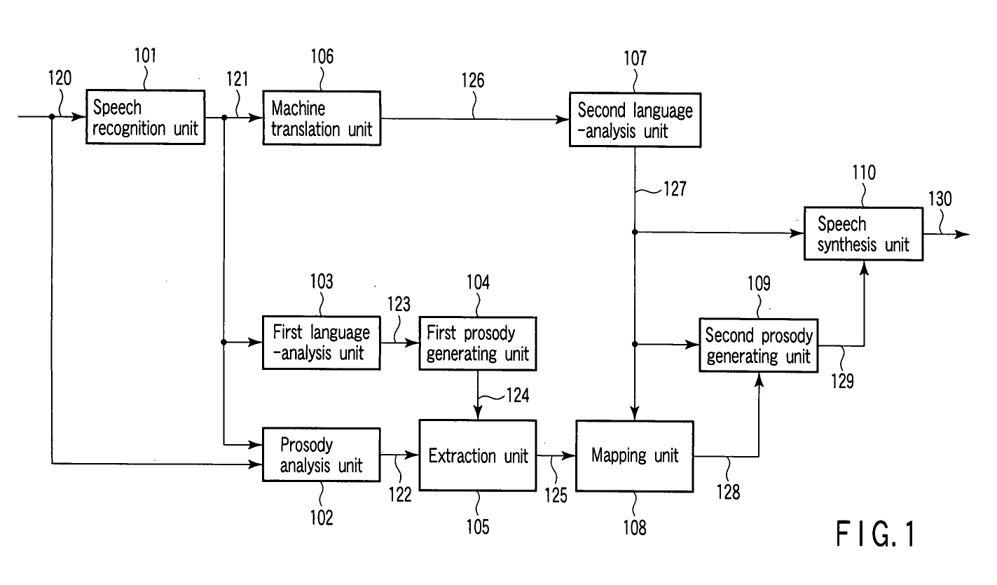

As shown in FIG. 1, a speech translation apparatus according to an embodiment of the invention has a speech recognition unit 101, a prosody analysis unit 102, a first language-analysis unit 103, a first generating unit 104, an extraction unit 105, a machine translation unit 106, a second language-analysis unit 107, a mapping unit 108, a second generating unit 109, and a speech synthesis unit 110.

The speech recognition unit 101 recognizes input speech 120 of a first language and generates a recognized text 121 that describes the input speech 120 most faithfully. Although the speech recognition unit 101 is not defined in detail in terms of operation, it has a microphone that receives the input speech 120 and generates a speech signal from the input speech 120. The speech recognition unit 101 performs analog-to-digital conversion on the speech signal, generating a digital speech signal, then extracts a characteristic quantity, such a linear predictive coefficient or a frequency cepstrum coefficient, from the digital speech signal, and recognizes the input speech 120 by using an acoustic model. The acoustic model is, for example, a hidden Markov model (HMM).

The prosody analysis unit 102 receives the input speech 120 and analyzes the words constituting the input speech 120, one by one. More specifically, the unit 102 analyzes the prosody information about each word, such as changes in basic frequency and average power. The result of this analysis is input, as original prosody information 122, to the extraction unit 105.

The first language-analysis unit 103 receives the recognized text 121 and analyzes the linguistic information about the text 121, such as the boundaries of words, parts of speech, and sentence structure, thus generating first linguistic information 123. The first linguistic information 123 is input to the first generating unit 104. The first generating unit 104 generates first synthesized prosody information 124 from the first linguistic information 123. The first synthesized prosody information 124 is input to the extraction unit 105.

The extraction unit 105 compares the original prosody information 122 with the first synthesized prosody information 124 and extracts paralinguistic information 125. The original prosody information 122 has been acquired by directly analyzing the input speech 120. Therefore, the original prosody information 122 contains not only the linguistic information, but also paralinguistic information such as the speaker's emphasis, intension and attitude. On the other hand, the first synthesized prosody information 124 has been generated from the first linguistic information 123 acquired by analyzing the recognized text 121. However, the first synthesized prosody information 124 does not contain the paralinguistic information, which is contained in the input speech 120 and lost as the input speech 120 is converted to the recognized text 121 in the speech recognition unit 101. Hence, the difference between the original prosody information 122 and the first synthesized prosody information 124 corresponds to the paralinguistic information 125. Based on this difference, the extraction unit 105 extracts the paralinguistic information 125, word for word. The paralinguistic information 125, thus extracted, is input to the mapping unit 108.

The input speech has been produced by an unspecific person having a particular linguistic idiosyncrasy. Therefore, the extraction unit 105 normalizes both the original prosody information 122 and the first synthesized prosody information 124. For example, the extraction unit 105 normalizes, as characteristic quantity of the original prosody information 122, the ratio of the peak value of each word in the original prosody information 122 to the linear regression value of the original prosody information 122, such as changes of basic frequency and average power with time. The extraction unit 105 normalizes the first synthesized prosody information 124, too, in a similar manner. Then, the extraction unit 105 compares the words, one with another, in terms of characteristic quantity, and extracts the paralinguistic information 125. More precisely, the unit 105 extracts, as paralinguistic information 125, a value obtained by subtracting the characteristic quantity calculated for the word by normalizing the first synthesized prosody information 124, from the characteristic quantity calculated for each word by normalizing the original prosody information 122.

The machine translation unit 106 performs machine translation, translating the recognized text 121 to a text of the second language, i.e., translated text 126, which is input to the second language-analysis unit 107. That is, the machine translation unit 106 uses, for example, a dictionary database, a analytic syntax database, a language conversion database, and the like (which are not shown), performing morpheme analysis and structure analysis on the recognized text 121. The unit 106 thus converts the recognized text 121 to the translated text 126. Further, the machine translation unit 106 inputs the information representing the relation between each word of the recognized text 121 and the equivalent word of the translated text 126, together with the translated text 126, to the second language-analysis unit 107.

As the first language-analysis unit 103 does, the second language-analysis unit 107 analyzes the linguistic information about the translated text 126, such as the boundaries of words, parts of speech, and sentence structure, thus generating second linguistic information 127. The second linguistic information 127 is input to the mapping unit 108, second generating unit 109 and speech synthesis unit 110.

The mapping unit 108 applies the paralinguistic information 125 about each word, which the extraction unit 105 has extracted, to the equivalent word (translated word) in the second language. That is, the mapping unit 108 allocates the paralinguistic information 125 to each of the translated words in accordance with synonymity. More specifically, the mapping unit 108 refers to the second linguistic information 127 supplied from the second language-analysis unit 107, acquiring information that represents the correspondence between each first-language word in the recognized text 121 and the equivalent second-language word in the translated text 126. In accordance with this correspondence, the mapping unit 108 allocates the paralinguistic information 125 to the equivalent word (translated word) in the translated text 126, thus mapping the paralinguistic information 125. The mapping unit 108 may allocate the paralinguistic information 125 in accordance with a preset conversion rule that is applied in the case where a word of the first language does not simply correspond to only one word of the second language, or corresponds to two different words of the second language. The paralinguistic information 125, thus mapped by the mapping unit 108, or mapped paralinguistic information 128, is input to the second generating unit 109.

The second generating unit 109 generates second synthesized prosody information 129 from the second linguistic information 127 and the mapped paralinguistic information 128. More specifically, the second generating unit 109 generates synthesized prosody information from only the second linguistic information 127, and then applies the paralinguistic information 128 to the synthesized prosody information, thereby generating the second synthesized prosody information 129. The paralinguistic information 128 may be, for example, a difference in terms of the above-mentioned ratios of the peak values to the linear regression values. In this case, the second generating unit 109 adds the paralinguistic information 128 to the ratio of the synthesized prosody information generated from the second linguistic information only, thereby correcting the ratio, and generates second synthesized prosody information 129 based on the ratio thus corrected. The second synthesized prosody information 129 is input to the speech synthesis unit 110.

The speech synthesis unit 110 synthesizes output speech 130, using the second linguistic information 127 and the second synthesized prosody information 129.

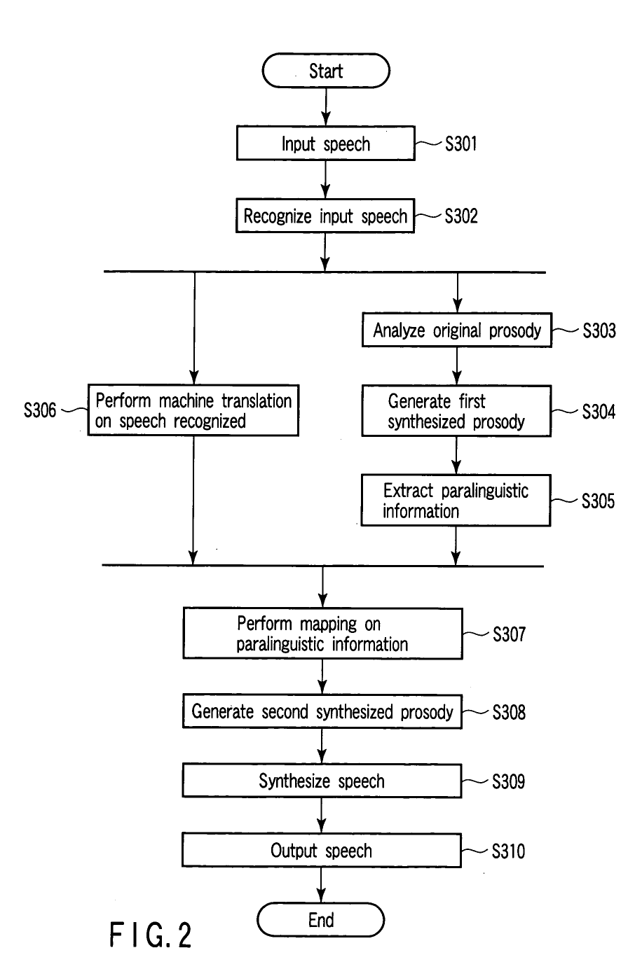

How the speech translating apparatus shown in FIG. 1 operates will be explained, with reference to the flowchart of FIG. 2.

First, speech 120 is input to the speech recognition unit 101 (Step S301). Assume that the speech 120 input is, for example, a spoken English text “Today's game is wonderful,” in which the speaker put emphasis to the word “Today's.” The speech recognition unit 101 recognizes the speech 120 input in Step S301, and outputs a recognized text 121 of “Today's game is wonderful” (Step S302).

Next, the speech translation apparatus of FIG. 1 performs a parallel process. In other words, the speech translation apparatus of FIG. 1 performs processes of Steps S303 to S305 and a process of S306 in parallel. Subsequently, the speech translation apparatus performs Step 307.

In Step S303, the prosody analysis unit 102 analyzes the prosody information about the input speech 120. The unit 102 analyzes the words constituting the input speech 120, one by one, in terms of basic-frequency change with time, generating original prosody information 122. The original prosody information 122 is input to the extraction unit 105.

The first language-analysis unit 103 analyzes the linguistic information about the recognized text 121, generating first linguistic information 123. The first linguistic information 123 is input to the first generating unit 104. The first generating unit 104 generates first synthesized prosody information 124 from the first linguistic information 123. The first synthesized prosody information 124 is input to the extraction unit 105 (Step S304). Note that Step S303 and Step S304 may be performed in reverse order.

Then, the extraction unit 105 compares the original prosody information 122 with the first synthesized prosody information 124 and extracts paralinguistic information 125 (Step S305). More precisely, the extraction unit 105 extracts the paralinguistic information 125 by using such a method as will be described below.

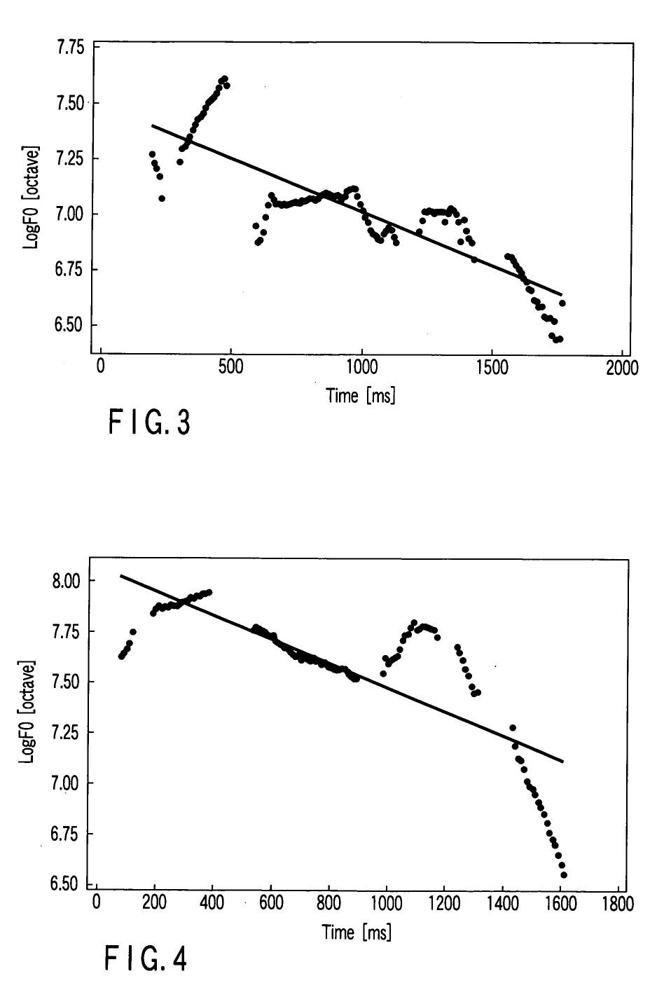

FIG. 3 is a graph representing the result of analyzing the basic frequency in the case where an adult male produces a spoken text “Today's game is wonderful,” placing emphasis on “Today's.” In FIG. 3, time [ms] is plotted on the abscissa, and logarithmic basic-frequency, and the base of which is 2, is plotted on the ordinate. In FIG. 3, the dots indicate the result of analysis, and a linear regression line is drawn. The ratio of the peak value of basic frequency to the linear regression value shown in FIG. 3 (hereinafter called first characteristic quantity) is given in the following Table 1.

TABLE 1

| | First |
|---|---|
| | Characteristic |
| Word(s) | Quantity |
| Today's | 1.047 |
| Game | 1.013 |
| is | 1.026 |
| wonderful | 1.011 |

FIG. 4 is a graph representing the result of analysis of basic frequency, performed on an adult female voice synthesized from the linguistic information acquired by analyzing the text “Today's game is wonderful”. In FIG. 4, time [ms] is plotted on the abscissa, and logarithmic basic-frequency, the base of which is 2, is plotted on the ordinate, the dots indicate the result of analysis, and a linear regression line is drawn. The ratio of the peak value of basic frequency to the linear regression value shown in FIG. 4 (hereinafter called second characteristic quantity) is given in the following table 2.

TABLE 2

| | Second |
|---|---|
| | Characteristic |
| Word(s) | Quantity |
| Today's | 1.012 |
| game | 1.003 |
| is | 1.052 |
| wonderful | 1.052 |

The extraction unit 105 compares the first characteristic quantity deriving from the original prosody information 122 with the second characteristic quantity deriving from the first synthesized prosody information 124, thereby extracting paralinguistic information 125. For example, the extraction unit 105 subtracts the second characteristic quantity from the first characteristic quantity, as shown in Table 3, generating paralinguistic information 125. The paralinguistic information 125 is input to the mapping unit 108.

TABLE 3

| | Paralinguistic |
|---|---|
| Word(s) | Information |
| Today's | 0.035 |
| game | 0.011 |
| is | −0.025 |
| wonderful | −0.041 |

In Step S306, the machine translation unit 106 performs machine translation on the recognized text 121. In this instance, the unit 106 translates the recognized text 121 to a translated text 126 in the second language, which is “Kyou no shiai ha subarashikatta.” In the process of generating the translated text 126, the machine translation unit 106 holds the correspondence between each word in the recognized text 121 and the equivalent word in the translated text 126, and inputs such word-to-word correspondence as shown in Table 4 to the second language-analysis unit 107, together with the translated text 126.

TABLE 4

| Word(s) | Translated Word(s) |
|---|---|
| Today's | Kyou no |
| Game | Shiai ha |
| is | |
| Wonderful | Subarashikatta |

In Step S307, the mapping unit 108 allocates the paralinguistic information 125 extracted for each word in Step S305, to the equivalent translated word in the translated text 126. In order to allocate the paralinguistic information 125 in this way, the mapping unit 108 uses the second linguistic information 127 input from the second language-analysis unit 107 and the word-to-word correspondence shown in Table 4. First, the mapping unit 108 first uses the second linguistic information 127, thereby detecting the words constituting the translated text 126. Then, the mapping unit 108 refers to Table 4, allocating the paralinguistic information 125 shown in Table 3 to the words of the second language, which are equivalent to the words “Today's,” “game,” “is” and “wonderful” constituting the recognized text 121, respectively. All items of the paralinguistic information 125, which have been extracted in Step S305, can of course be allocated to the translated text 126. Instead, only the positive-value items may be allocated to the translated text 126. In the case of Table 3, for example, the paralinguistic information items for the words “is” and “wonderful” have negative values. Therefore, the mapping unit 108 does not allocate the paralinguistic information 125 to the translated word “subarashikatta,” and performs such allocation as shown in Table 5. The following description is based on the assumption that the mapping unit 108 performs the allocation shown in Table 5.

TABLE 5

| | Paralinguistic |
|---|---|
| Translated Word(s) | Information |
| Kyou no | 0.035 |
| Shiai ha | 0.011 |
| Subarashikatta | |

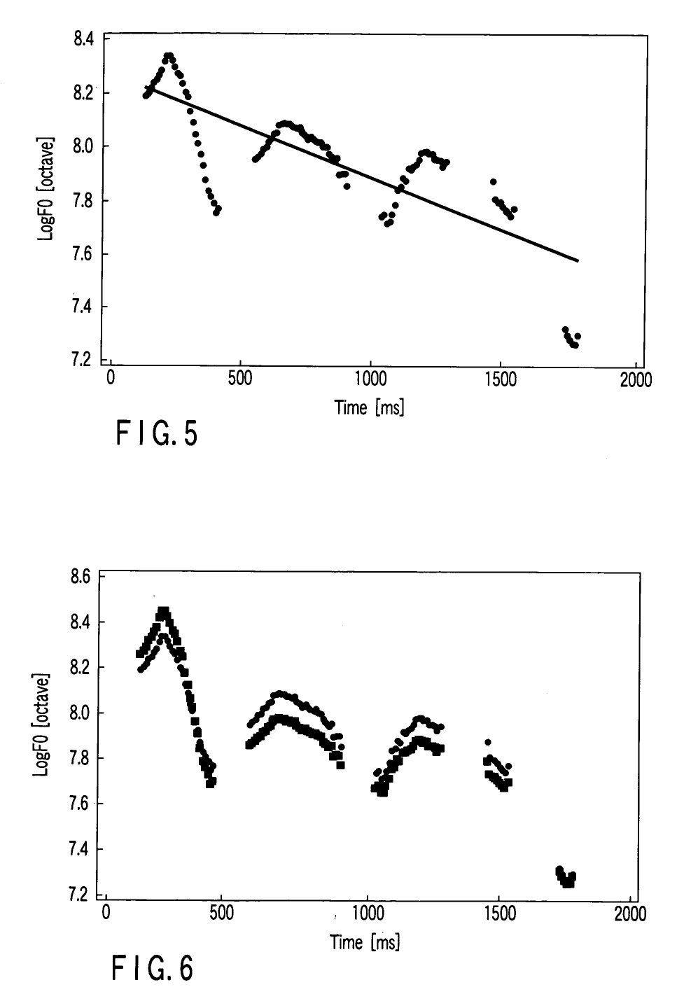

Next, the second generating unit 109 generates second synthesized prosody information 129 from the paralinguistic information 128 that has been allocated in Step S207 (Step S308). More specifically, the second generating unit 109 first generates synthesized prosody information from the second linguistic information 127 only. FIG. 5 shows the result of the analysis of the basic frequency, performed on an adult female voice synthesized from the linguistic information acquired by analyzing the text “Kyou no shiai ha subarashikatta. In FIG. 5, time [ms] is plotted on the abscissa, and logarithmic basic-frequency, the base of which is 2, is plotted on the ordinate, the dots indicate the result of analysis, and a linear regression line is drawn. The ratio of the peak value of basic frequency to the linear regression value shown in FIG. 5 (hereinafter called third characteristic quantity) is given in the following table 6.

TABLE 6

| | Third |
|---|---|
| | Characteristic |
| Translated Word(s) | Quantity |
| Kyou no | 1.008 |
| Shiai ha | 0.979 |
| Subarashikatta | 0.966 |

The second generating unit 109 generates second synthesized prosody information 129, by using the fourth characteristic amount obtained by reflecting the paralinguistic information 128 in the third characteristic quantity acquired from the synthesized prosody information that has been generated from the second linguistic information 127 only. For example, the second generating unit 109 adds the paralinguistic information 128 to the third characteristic quantity, thereby producing the fourth characteristic quantity. If produced by adding the paralinguistic information 128 shown in FIG. 5 to the third characteristic quantity shown in Table 6, the fourth characteristic quantity will have the value shown in Table 7.

TABLE 7

| Translated Word(s) | Fourth Characteristic Quantity |
|---|---|
| Kyou no | 1.044 |
| Shiai ha | 0.99 |
| Subarashikatta | 0.966 |

Using the fourth characteristic quantity, the second generating unit 109 calculates the peak value fₚₑₐₖ (wᵢ) of the logarithmic basic-frequency of the second synthesized prosody information 129 for the ith word wⱼ (i is an positive integer), in accordance with the following equation (1).

fₚₑₐₖ(wᵢ)=fₗᵢₙₑₐᵣ(wᵢ)×p_{paralingual}(wᵢ) (1)

where fₗᵢₑₐᵣ (wᵢ) is the linear regression value of the logarithmic basic-frequency that the word wᵢ in the synthesized prosody information has the peak value at the peak value of the word wᵢ, and P_{paralingual} (wi) is the fourth characteristic quantity that the word wᵢ has.

Using the above-mentioned value fₚₑₐₖ (wᵢ), the second generating unit 109 calculates a target locus f_{paralingual} (t,wᵢ) for the logarithmic basic-frequency of the second synthesized prosody information in accordance with the following equation (2).

$${f}_{paralingual} ( t , {w}_{i} ) = \frac{( {f}_{normal} ( t , {w}_{i} ) - {f}_{min} ( {w}_{i} ) ) \times ( {f}_{peak} ( {w}_{i} ) - {f}_{min} ( {w}_{i} ) )}{{f}_{max} ( {w}_{i} ) - {f}_{min} ( {w}_{i} )} + {f}_{min} ( {w}_{i} ) \qquad ( 2 )$$

where fₙₒᵣₘₐₗ (t, wᵢ) is the locus of the logarithmic basic-frequency at the word wᵢ in the synthesized prosody information generated to the second linguistic information 127 only, and fₘᵢₙ (wᵢ) and fₘₐₓ (wᵢ) are the minimum value and maximum value of the locus fₙₒᵣₘₐₗ (t, wᵢ), respectively.

If the target locus f_{paralingual} (t, wᵢ) rises above the upper limit of the prescribed logarithmic basic-frequency or falls below the lower limit thereof, the second generating unit 109 adjusts this locus in accordance with the equation (3) given below. The upper limit and lower limit vary, depending on the type of the output speech. That is, they have appropriate values preset in accordance with the sex and age of a person who is supposed to produce the output speech.

$${f}_{final} ( t ) = \frac{( {f}_{paralingual} ( t ) - {F}_{bottom} ) \times ( {F}_{top} - {F}_{bottom} )}{{f}_{MAX} - {F}_{bottom}} + {F}_{bottom} \qquad ( 3 )$$

where Fₜₒₚ and F_{bottom} are the upper limit and lower limit of the logarithmic basic-frequency of the output speech, respectively, f_{paralingual} (t) is a target locus for the logarithmic basic-frequency of the translated text obtained by adding the above-mentioned target locus f_{paralingual} (t, wᵢ), f_{MAX} is the maximum value for the target locus f_{paralingual} (t), f_{final} (t) is a locus of the logarithmic basic-frequency that is finally used as second synthesized prosody information 129. FIG. 6 shows a logarithmic basic-frequency locus calculated from the logarithmic basic-frequency locus shown in FIG. 5 and the fourth characteristic quantity shown in FIG. 7, in accordance with the equations (1) to (3). In FIG. 6, round dots indicate the logarithmic basic-frequency locus shown in FIG. 5, and square dots indicate a locus obtained by reflecting the fourth characteristic quantity in the logarithmic basic-frequency locus of FIG. 5.

Next, the speech synthesis unit 110 generates output speech 130, by synthesizing the second synthesized prosody information 129 acquired in Step S308 with the second linguistic information 127 input from the second language-analysis unit 107 (Step S309). The output speech 130 generated in Step S309 is output from a loudspeaker (not shown) (Step S310).

As described above, the speech translation apparatus according to the present embodiment compares, for each word, the original prosody information with the prosody information synthesized based on a recognized text, thereby extracting paralinguistic information, and reflects the paralinguistic information in the translated word equivalent to the word. The apparatus can therefore generate output speech that reflects the paralinguistic information such as the speaker's emphasis, intension and attitude. Hence, the speech translation apparatus can help its users to promote smooth communication. Moreover, the apparatus can reflect the paralinguistic information in the output speech even if the first language is a Western language in which the word order changes but a little or Chinese which has no case particles. In the scheme explained above, prosody information is extracted, as paralinguistic information, from the original prosody information representing the change of basic frequency with time. Instead, the paralinguistic information may be extracted from original prosody information representing the change of average power with time.

### Second Embodiment

In the first embodiment described above, the paralinguistic information is extracted, as prosody information, from the change of the basic frequency with time and the change of the average power with time, and is then reflected in the output speech. A speech translation apparatus according to a second embodiment of the invention will be described, in which paralinguistic information is extracted from the duration of each word in input speech and is reflected in output speech. The following description centers mainly on the components that differs from those of the first embodiment.

The duration of each word cannot be expressed in terms of any changes with time. Therefore, in the present embodiment, the paralinguistic information is a vector one component of which is the characteristic quantity calculated from the duration of each word. More specifically, the prosody analysis unit 102 analyzes each word in the input speech 120, to measure the durations of the phonetic units constituting the word. The phonetic unit may differ, in accordance with the type of the first language, i.e., the language of the input speech 120. If the first language is English or Chinese, the syllable is appropriate as phonetic unit. If the first language is Japanese, the mora is appropriate as phonetic unit.

Table 8 shows the durations of the syllables (i.e., phonetic units) constituting the spoken text “Today's game is wonderful,” produced by an adult male, who has placed emphasis on the word “Today's.”

TABLE 8

| | | Main Stress of | Duration |
|---|---|---|---|
| Word(s) | Syllable | the Content Word | (sec) |
| Today's | to | | 0.09 |
| | day's | ∘ | 0.40 |
| game | game | ∘ | 0.35 |
| is | is | | 0.20 |
| wonderful | won | ∘ | 0.19 |
| | der | | 0.07 |
| | ful | | 0.30 |
| | average | | 0.23 |

In the present embodiment, the duration of each syllable is normalized to a ratio of the duration to the average syllable duration (hereinafter referred to as normalized duration). Table 9 shows the normalized durations obtained by normalizing the syllable durations specified in Table 8.

TABLE 9

| | | Main Stress of | Normalized |
|---|---|---|---|
| Word(s) | Syllable | the Content Word | Duration |
| Today's | to | | 0.39 |
| | day's | ∘ | 1.75 |
| game | game | ∘ | 1.53 |
| is | is | | 0.88 |
| wonderful | won | ∘ | 0.83 |
| | der | | 0.31 |
| | ful | | 1.31 |

In this embodiment, the extraction unit 105 determines characteristic quantities for the respective words, on the basis of the normalized durations defined above. The characteristic quantity may differ, from one language to another. The characteristic quantity of, for example, an English word may be the normalized duration of the syllable that has the main stress of the content word. If the input speech is a spoken Japanese text, the average of the normalized durations of the morae constituting any content word is the characteristic quantity of the word. Table 10 shows the characteristic quantities of the respective content words (hereinafter referred to as first characteristic quantities), which has been obtained from the original prosody information 122, i.e., the normalized durations shown in FIG. 9.

TABLE 10

| Word(s) | First Characteristic Quantity |
|---|---|
| Today's | 1.75 |
| game | 1.53 |
| wonderful | 0.83 |

Thus, the extraction unit 105 of the speech translation apparatus according to the present embodiment determines characteristic quantities for the respective words. The extraction unit 105 also determines, in a similar manner, the characteristic quantities (hereinafter referred to as second characteristic quantities) of the respective words in the first synthesized prosody information 124. Table 11 shows the durations of the respective syllables in the first synthesized prosody information 124 about the text “Today's game is wonderful” and the average duration of these syllables.

TABLE 11

| | Main Stress of | Duration |
|---|---|---|
| Syllable | the Content Word | (sec) |
| To | | 0.13 |
| day's | ∘ | 0.34 |
| game | ∘ | 0.35 |
| is | | 0.15 |
| won | ∘ | 0.24 |
| der | | 0.12 |
| ful | | 0.31 |
| average | | 0.23 |

Table 12 shows the normalized durations of the respective syllables, each being a ratio of the duration to the average syllable duration.

TABLE 12

| | | Main Stress of | Normalized |
|---|---|---|---|
| Word(s) | Syllable | the Content Word | Duration |
| Today's | to | | 0.54 |
| | day's | ∘ | 1.45 |
| game | game | ∘ | 1.50 |
| is | is | | 0.63 |
| wonderful | won | ∘ | 1.03 |
| | der | | 0.52 |
| | ful | | 1.32 |

Table 13 shows the second characteristic quantities of the words, each obtained from that syllable in each content word, which has the main stress.

TABLE 13

| Word(s) | Second Characteristic Quantity |
|---|---|
| Today's | 1.45 |
| game | 1.50 |
| wonderful | 1.03 |

The extraction unit 105 extracts, as paralinguistic information 125, the difference between the first characteristic quantity deriving from the original prosody information 122 and the second characteristic quantity deriving from the first synthesized prosody information 124. Table 14 shows the paralinguistic information 125 extracted from the first characteristic quantities shown in Table 10 and the second characteristic quantities shown in Table 13.

TABLE 14

| Word(s) | Paralinguistic Information |
|---|---|
| Today's | 0.30 |
| game | 0.03 |
| wonderful | −0.20 |

The mapping unit 108 multiplies each word in the translated text by a coefficient for correcting for the difference in characteristic between the languages, in the process of mapping the paralinguistic information 125. More precisely, the mapping unit 108 multiplies the paralinguistic information 125 by 0.5 in the translation from English to Japanese, and by 2.0 (i.e., reciprocal to 0.5) in the translation from Japanese to English. Any word may not be subjected to mapping if the absolute value of the paralinguistic information 125 becomes smaller than a preset threshold. That is, 0.0 may be applied to this word. The mapping unit 108 performs mapping on positive values only or on both positive values and negative values. The following explanation relates the case where the mapping unit 108 performs mapping on both positive values and negative values. Table 15 shows the result of the paralinguistic information mapping in which correction coefficient 0.5 is applied to the paralinguistic information shown in Table 14 and the above-mentioned threshold is applied.

TABLE 15

| Translated Word(s) | Paralinguistic Information |
|---|---|
| Kyou no | 0.15 |
| Shiai ha | 0.00 |
| Subarashikatta | −0.10 |

Assume that second generating unit 109 generates synthesized prosody information about a synthesized Japanese speech in female voice, from only the second linguistic information 127 obtained by analyzing a spoken Japanese text of “Kyou no shiai ha subarashikatta.” Table 16 shows the durations the respective morae represented by this synthesized prosody information and, also, the average value of these durations. Here, “Q” indicates double or long consonant in the Table 16 and after-mentioned Tables 17, 20 and 21.

TABLE 16

| Translated Word(s) | Mora | Duration (sec) |
|---|---|---|
| Kyou no | kyo | 0.21 |
| | o | 0.11 |
| | no | 0.13 |
| Shiai ha | shi | 0.20 |
| | a | 0.11 |
| | i | 0.08 |
| | wa | 0.12 |
| Subarashikatta | su | 0.16 |
| | ba | 0.12 |
| | ra | 0.11 |
| | shi | 0.10 |
| | ka | 0.17 |
| | Q | 0.10 |
| | ta | 0.17 |
| | average | 0.13 |

Table 17 shows the values acquired by normalizing the durations of the respective morae (i.e., durations shown in Table 16), with an average duration.

TABLE 17

| Translated Word(s) | Mora | Normalized Duration |
|---|---|---|
| Kyou no | kyo | 1.56 |
| | o | 0.79 |
| | no | 0.98 |
| Shiai ha | shi | 1.50 |
| | a | 0.79 |
| | i | 0.62 |
| | wa | 0.87 |
| Subarashikatta | su | 1.17 |
| | ba | 0.90 |
| | ra | 0.79 |
| | shi | 0.71 |
| | ka | 1.30 |
| | Q | 0.78 |
| | ta | 1.26 |

As has been pointed out, the characteristic quantity of each content word in any Japanese text is an average of the normalized durations of the morae constituting the content word. Table 18 shows characteristic quantities obtained from the information about the synthesized prosody the second generating unit 109 has generated from the second linguistic information 127 only. These characteristic quantities (hereinafter referred to as third characteristic quantities) are obtained from the respective mora durations that are shown in Table 17.

TABLE 18

| Translated Word(s) | Third Characteristic Quantity |
|---|---|
| Kyou no | 1.11 |
| Shiai ha | 0.94 |
| Subarashikatta | 0.99 |

The second generating unit 109 reflects the paralinguistic information 128 in the third characteristic quantities based on only the second linguistic information 127 so acquired as described above. Table 19 shows characteristic quantities (hereinafter referred to as fourth characteristic quantities), each of which is a third characteristic quantity in which the paralinguistic information shown in Table 15 is reflected.

TABLE 19

| Translated Word(s) | Fourth Characteristic Quantity |
|---|---|
| Kyou no | 1.26 |
| Shiai ha | 0.94 |
| Subarashikatta | 0.89 |

The second generating unit 109 corrects the normalized duration of each mora on the basis of a fourth characteristic quantity that reflects the paralinguistic information 128. More precisely, the second generating unit 109 multiplies the normalized mora duration (shown in Table 17) of each word by the ratio of the fourth characteristic quantity to the third characteristic quantity, either increasing or decreasing the normalized mora duration. Table 20 shows the normalized durations thus corrected.

TABLE 20

| Translated Word(s) | Mora | Normalized Duration |
|---|---|---|
| Kyou no | kyo | 1.77 |
| | o | 0.89 |
| | no | 1.11 |
| Shiai ha | shi | 1.50 |
| | a | 0.79 |
| | i | 0.62 |
| | wa | 0.87 |
| Subarashikatta | su | 1.06 |
| | ba | 0.81 |
| | ra | 0.71 |
| | shi | 0.64 |
| | ka | 1.17 |
| | Q | 0.70 |
| | ta | 1.13 |

The second generating unit 109 then calculates the duration of each mora from the normalized duration thus corrected. To be more specific, the second generating unit 109 multiplies the normalized duration, thus corrected, by the average duration (=0.13 sec) of the morae, finding the duration of each mora in the second synthesized prosody information 129. Table 21 shows the durations of the respective morae in the second synthesized prosody information 129.

TABLE 21

| Translated Word(s) | Mora | Duration (sec) |
|---|---|---|
| Kyou no | kyo | 0.24 |
| | o | 0.12 |
| | no | 0.15 |
| Shiai ha | shi | 0.20 |
| | a | 0.11 |
| | i | 0.08 |
| | wa | 0.12 |
| Subarashikatta | su | 0.14 |
| | ba | 0.11 |
| | ra | 0.09 |
| | shi | 0.09 |
| | ka | 0.16 |
| | Q | 0.09 |
| | ta | 0.15 |

The speech synthesis unit 110 synthesizes the waveform of the output speech, by using the second linguistic information 127 output from the second language-analysis unit 107 and the durations of the morae in the second synthesized prosody information 129 output from the second generating unit 109. Depending on the scheme employed to generate the waveform of the output speech, the waveform must be split into the durations of phonemes such as consonants and vowels. The difference between two durations of the mora of each word, one not changed, and the other changed, by the second generating unit 109, is allocated to the consonants or vowels in the word. The ratio of the consonants allocated with the duration difference to the vowels allocated with the duration difference may be preset. Then, the waveform of the output speech can be split into durations, each ranging from this difference to the duration of a phoneme. How to split the waveform will not be explained in detail.

As has been described, the paralinguistic information is extracted by using the ratio of the duration of each phonetic unit to the average duration of phonetic units in the speech translation apparatus according to the present embodiment. Hence, the apparatus can generate output speech that reflects the paralinguistic information such as the speaker's emphasis, intension and attitude, as the speech translation apparatus according to the first embodiment. The apparatus can therefore help the users to promote smooth communication. In addition, the apparatus can reflect the paralinguistic information in the output speech even if the input speech is produced in a Western language in which the word order changes but a little or Chinese which has no case particles.

The speech translation apparatus can use, for example, a general-purpose computer as its main hardware. In other words, many components of this speech translation apparatus can be implemented as the microprocessor incorporated in the computer executes various programs. The programs may be stored in a computer readable storage, installed in the computer, and read into the computer from recording medium such as CD-ROMs, or distributed via a network and then read into the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech translation apparatus comprising:
a speech recognition unit configured to recognize input speech of a first language to generate a first text of the first language;
a prosody analysis unit configured to analyze a prosody of the input speech to obtain original prosody information;
a first language-analysis unit configured to split the first text into first words to obtain first linguistic information;
a first generating unit configured to generate first synthesized prosody information based on the first linguistic information;
an extraction unit configured to compare the original prosody information with the first synthesized prosody information to extract paralinguistic information about each of the first words;
a machine translation unit configured to translate the first text to a second text of a second language;
a second language-analysis unit configured to split the second text into second words to obtain second linguistic information;
a mapping unit configured to allocate the paralinguistic information about each of the first words to each of the second words in accordance with synonymity;
a second generating unit configured to generate second synthesized prosody information based on the second linguistic information and the paralinguistic information allocated to each of the second words; and
a speech synthesis unit configured to synthesize output speech based on the second linguistic information and the second synthesized prosody information.

2. The apparatus according to claim 1, wherein the extraction unit normalizes the original prosody information to calculate a first characteristic quantity for each of the first words, and normalizes the first synthesized prosody information to calculate a second characteristic quantity for each of the first words, and compares the first characteristic quantity with the second characteristic quantity to extract the paralinguistic information about each of the first words.

3. The apparatus according to claim 1, wherein the extraction unit normalizes the original prosody information to calculate a first characteristic quantity for each of the first words, and normalizes the first synthesized prosody information to calculate a second characteristic quantity about each of the first words, and compares the first characteristic quantity with the second characteristic quantity to extract the paralinguistic information about each of the first words; and the second generating unit generates third synthesized prosody information based on the second linguistic information, normalizes the third synthesized prosody information to calculate a third characteristic quantity for each of the second words, corrects the third characteristic quantity based on the paralinguistic information to calculate a fourth characteristic quantity, and uses the fourth characteristic quantity to generate the second synthesized prosody information.

4. The apparatus according to claim 3, wherein the paralinguistic information is a value obtained by subtracting the second characteristic quantity from the first characteristic quantity, and the fourth characteristic quantity is a value obtained by adding the paralinguistic information to the third characteristic quantity.

5. The apparatus according to claim 4, wherein the mapping unit allocates the paralinguistic information to each of the second words only when the paralinguistic information is a positive value.

6. The apparatus according to claim 3, wherein the first characteristic quantity is a ratio of a peak value to a linear regression value of a basic frequency of the original prosody information for each of the first words; the second characteristic quantity is a ratio of a peak value to a linear regression value of a basic frequency of the first synthesized prosody information for each of the first words; and the third characteristic quantity is a ratio of a peak value to a linear regression value of a basic frequency of the third synthesized prosody information for each of the second words.

7. The apparatus according to claim 3, wherein the first characteristic quantity is a ratio of a peak value to a linear regression value of an average power of the original prosody information for each of the first words; the second characteristic quantity is a ratio of a peak value to a linear regression value of an average power of the first synthesized prosody information for each of the first words; and the third characteristic quantity is a ratio of a peak value to a linear regression value of an average power of the third synthesized prosody information for each of the second words.

8. The apparatus according to claim 3, wherein the first characteristic quantity is determined by a ratio of a duration of each of first phonetic units obtained by splitting each of the first words, to an average duration of the first phonetic units about the original prosody information; the second characteristic quantity is determined by a ratio of the duration of each the first phonetic units to an average duration of the first phonetic units about the first synthesized prosody information; and the third characteristic quantity is determined by a ratio of the duration of each of second phonetic units obtained by splitting each of the second word, to an average duration of the second phonetic units about the third synthesized prosody information.

9. A speech translation method comprising:
recognizing input speech of a first language to generate a first text of the first language;
analyzing a prosody of the input speech to obtain original prosody information;
splitting the first text into first words to obtain first linguistic information;
generating first synthesized prosody information based on the first linguistic information;
comparing the original prosody information with the first synthesized prosody information to extract paralinguistic information about each of the first words;
translating the first text to a second text of a second language;
splitting the second text into second words to obtain second linguistic information;
allocating the paralinguistic information about each of the first words to each of the second words in accordance with synonymity;
generating second synthesized prosody information based on the second linguistic information and the paralinguistic information allocated to each of the second words; and
synthesizing output speech based on the second linguistic information and the second synthesized prosody information.

10. A computer readable storage medium storing instructions of a computer program which when executed by a computer results in performance of steps comprising:
recognizing input speech of a first language to generate a first text of the first language;
analyzing a prosody of the input speech to obtain original prosody information;
splitting the first text into first words to obtain first linguistic information;
generating first synthesized prosody information based on the first linguistic information;
comparing the original prosody information with the first synthesized prosody information to extract paralinguistic information about each of the first words;
translating the first text to a second text of a second language;
splitting the second text into second words to obtain second linguistic information;
allocating the paralinguistic information about each of the first words to each of the second words in accordance with synonymity;
generating second synthesized prosody information based on the second linguistic information and the paralinguistic information allocated to each of the second words; and
synthesizing output speech based on the second linguistic information and the second synthesized prosody information.
